(19) United States
(12) Patent Application Publication
(10) Pub. No.: US 2023/0394543 A1
(43) Pub. Date: Dec. 7, 2023

(54) MULTI-VENDOR API MARKETPLACE WITH TARGETED CONTENT AND CUSTOMIZED RATE PLAN MONETIZAION CAPABILITIES

(71) Applicants: Venkat Madipadaga, Exton, PA (US); Ajay Naidu, Exton, PA (US)

(72) Inventors: Venkat Madipadaga, Exton, PA (US); Ajay Naidu, Exton, PA (US)

(21) Appl. No.: 18/331,107

(22) Filed: Jun. 7, 2023

Related U.S. Application Data
(60) Provisional application No. 63/350,009, filed on Jun. 7, 2022.

(51) Int. Cl. G06Q 30/0601; G06F 9/54

(52) U.S. Cl. CPC G06Q 30/0603; G06Q 30/0605; G06F 9/547

(57) ABSTRACT

A multi-vendor, network-accessible marketplace and a system and method for providing an multi-vendor, network-accessible marketplace for distributing application programming interfaces, otherwise referred to APIs, and other like products, is presented herein. For example, the multi-vendor, network-accessible API marketplace includes, among other features, targeted content and customized rate plan monetization capabilities. A publisher hub application is also included where publishers are arranged into several publisher groups and where each of the publishers are able to create APIs and other products through a product creation module. Once an API is created, it will be available for access through the product catalog provided in the multi-vendor, network-accessible marketplace.

### CLAIM OF PRIORITY/CROSS-REFERENCE TO RELATED APPLICATION

The present application is based on and a claim of priority is made under 35 U.S.C. § 119(e) to U.S. Provisional Patent Application No. 63/350,009, filed on Jun. 7, 2022, the contents of which are incorporated herein in their entirety by reference.

### FIELD OF THE INVENTION

The present invention is generally directed to a system and method for providing an online, internet or network-accessible marketplace for distributing APIs or application programming interfaces, and more specifically to a multi-vendor API marketplace with targeted content, customized rate plan monetization capabilities and other features described herein.

### BACKGROUND OF THE INVENTION

An application programming interface (referred to commonly as an API) is a set of definitions, instructions and/or protocols that can be used to build and integrate application software. For instance, an API allows a product or service to communicate with other products and services without having to know precisely how they are implemented. This, in turn, simplifies the process in the development of integrated applications or software, thereby saving time, money and other resources.

In several instances, it can be beneficial to share an API, for example, with select groups, partners, or even publicly, in that doing so can encourage developers to build a collection of applications or software around the API. Sharing an API can also lead to the development of new and perhaps unexpected outcomes or developments.

Due to the emerging importance of sharing APIs with others, it would be beneficial in the field to have a novel online or network-accessible marketplace where APIs and other like products can be exchanged or distributed. The proposed marketplace can be a multi-vendor marketplace such that several affiliated or unaffiliated entities (e.g., product owners, publishers, etc.) can create and distribute APIs and other products through the same marketplace or system.

It would also be beneficial if the marketplace allowed for some or all of the APIs or products to be monetized in that use of the product (or continued or extended use of the product) may be contingent upon the payment of a fee (e.g., an upfront fee, a recurring fee, etc.)

In addition, the system may include groups of publishers or a publisher hub application where publishers can belong to or associate with a group. The group can be organized with rules, specifications, and other requirements for the creation of APIs and other products by associated publishers.

### SUMMARY OF THE INVENTION

Accordingly, at least one embodiment of the present invention is directed to a system, method or marketplace wherein APIs (application programming interfaces) and other assets or products are published, distributed, sold or otherwise exchanged in some manner. In some embodiments, the present invention is directed to a system that includes a marketplace and/or method for providing a marketplace wherein APIs and other assets and products are distributed, sold or exchanged.

More specifically, as described in detail herein, the marketplace of at least one embodiment is implemented as an online, cloud-based, or network-accessible marketplace where a plurality of different product owners, publishers, providers or vendors can offer or provide one or more products to one or more users, developers, or consumers. In several embodiments provided herein, the marketplace is described as including a list or collection of products such as application programming interfaces, referenced as APIs, although other products may be provided, distributed, exchanged or sold in the marketplace including but in no way limited to software development toolkits or software development kits, referenced as SDKs, or other tools, interfaces, kits, or products that may be desired or used by software developers or programmers. It should be noted however, that other embodiments may not be limited to programming or development tools, kits or interfaces and may thus include a network-accessible marketplace for other products or other items.

Moreover, the marketplace and/or system or method of at least one embodiment of the present invention includes, among other items and features, a product catalog. As described herein, the product catalog may include, among other features, detailed or descriptive information about the various APIs, SDKs or other products that are made available in the marketplace. The product catalog is available for access though the network via user devices, which may be in the form of virtually any computer-based device.

Further embodiments of the present invention include a publisher hub module comprising a plurality of publisher groups, each of the plurality of publisher groups comprising a plurality of publishers associated therewith. In addition, the publisher hub module of at least one embodiment further includes a product creation module or application that is configured or otherwise designed to facilitate the creation of a product (e.g., API, API SKU, etc.) by at least one of the publishers.

Once the API, API SKU or other product is created by the published, e.g., using the product creation module of the publisher hub application, the product is then published or otherwise made accessible in the product catalog of the multi-vendor marketplace.

### BRIEF DESCRIPTION OF DRAWINGS

FIG. 1 is a schematic block diagram of the system as disclosed in accordance with at least one embodiment of the present invention.

FIGS. 2A-2C represent exemplary screenshots which illustrate the product catalog as described in accordance with at least one embodiment of the present invention.

FIGS. 3A-3D illustrate exemplary workflows for the product owner or vendor in accordance with at least one embodiment of the present invention.

FIGS. 4A-4B illustrate exemplary screenshots of a product owner or vendor onboarding a product.

FIGS. 5A-5D illustrate exemplary screenshots for monetizing a product and creation of a rate plan, as disclosed in accordance with at least one embodiment of the present invention.

FIG. 5E illustrates an exemplary screenshot where a product owner is able to edit an existing SKU or create a new API SKU.

FIGS. 6A-6B illustrate exemplary workflows for the developer or user in accordance with at least one embodiment of the present invention.

FIGS. 7A-7G illustrate exemplary screenshots of the system of at least one embodiment of the present invention from the perspective of the developer or user to purchase or subscribe to a rate plan for a developer app.

FIG. 7H illustrates an exemplary screenshot where a team app is created for a monetized SKU.

FIG. 7I illustrates an exemplary screenshot where the newly created team app is shown on the page with a Revenue search filter of “Monetized” selected.

FIG. 8 illustrates an exemplary workflow that allows a product owner to target products, SKUs and/or assets in accordance with at least one embodiment of the present invention.

FIGS. 9A-9C illustrate exemplary screenshots that allows the product owner to control the targeted audience for a product.

FIGS. 10A-D illustrate exemplary screenshots which allow the product owner to manage the targeted audience for assets or content associated with a product.

FIG. 11 is a schematic block diagram of the system as disclosed in accordance with another embodiment of the present invention.

FIG. 12 is a block diagram illustrating the publisher hub module as disclosed in accordance with at least one embodiment of the present invention.

FIG. 13 is a high-level flow chart of the method corresponding to the publisher hub module as disclosed in accordance with at least one embodiment of the present invention.

Like reference numerals refer to like parts throughout the several views of the drawings provided herein.

### DETAILED DESCRIPTION OF THE INVENTION

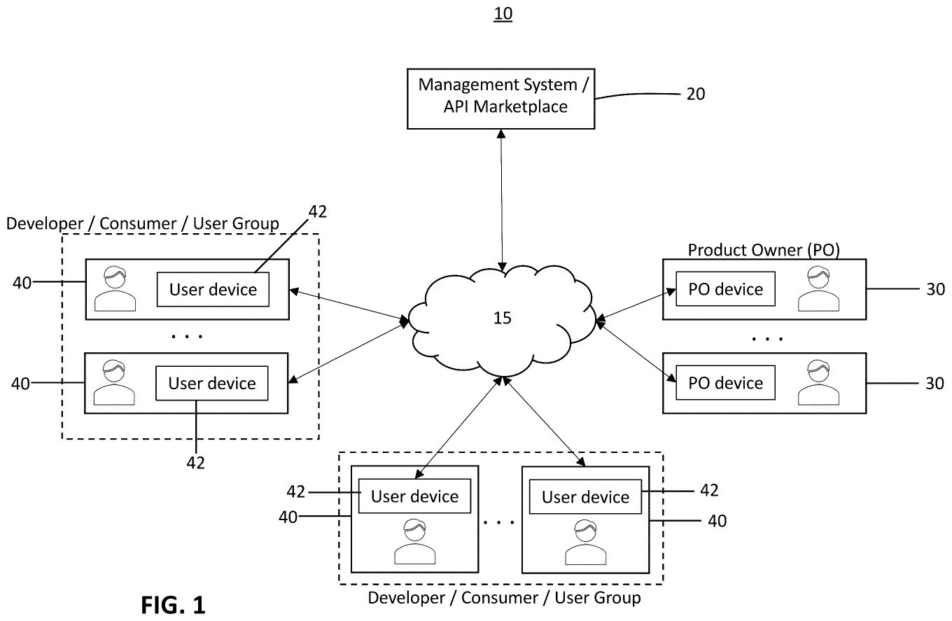

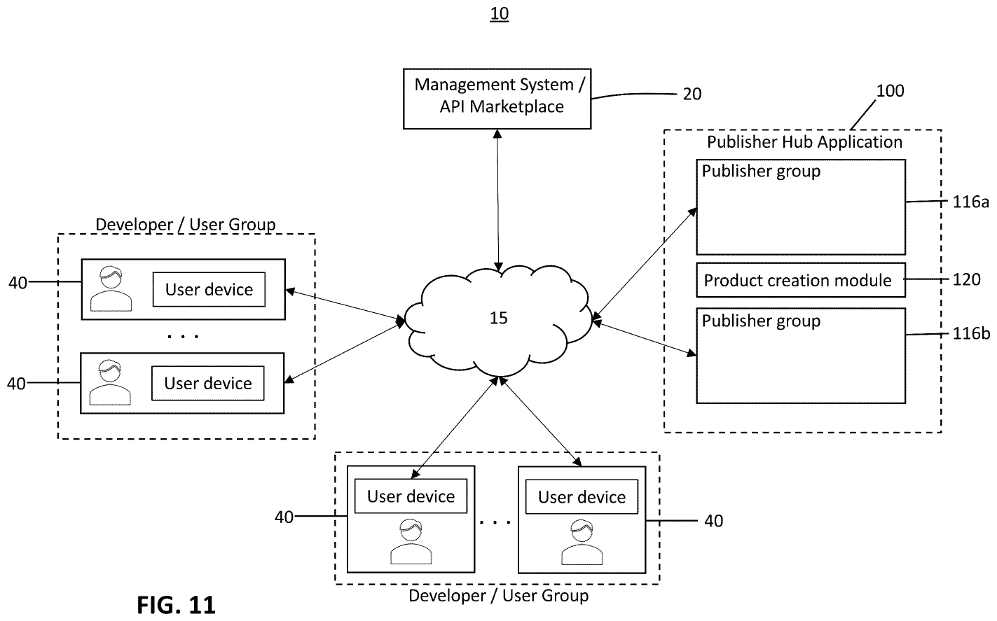

As shown in the accompanying drawings, and with particular reference to FIG. 1, at least one embodiment of the present invention is directed to a marketplace 20 wherein APIs (application programming interfaces) and other assets or products are published, distributed, sold or otherwise exchanged in some manner. In some embodiments, the present invention is directed to a system, generally represented as 10 in FIGS. 1 and 11, that includes a marketplace and/or method for providing a marketplace wherein APIs, SDKs and other assets and/or products are distributed, sold or exchanged.

More specifically, as described in detail herein, the marketplace 20 of at least one embodiment is implemented as an online, cloud-based, or network-accessible marketplace where a plurality of different product owners, publishers, providers or vendors, referenced as can offer or provide one or more products to one or more users, developers, or consumers referenced as 40. In several embodiments described herein, the marketplace 20 is described as providing products such as application programming interfaces, referenced as APIs, although other products may be provided, distributed, exchanged or sold in the marketplace 20 including but in no way limited to software development toolkits or software development kits, referenced as SDKs, or other tools, interfaces, kits, applications, modules, or products that may be desired or used by software developers or programmers. It should be noted however, that other embodiments may not be limited to programming or development tools, kits or interfaces and may thus include a network-accessible marketplace for other products or other items.

Moreover, the marketplace 20 and/or system 10 or method of at least one embodiment of the present invention includes, among other items and features, a product catalog, referenced as 110. As described herein, the product catalog 110 may include, among other features, detailed or descriptive information about the various APIs, SDKs or other products that are made available in the marketplace. The product catalog 110 is available for access though the network 15 via user devices 40, which may be in the form of virtually any computer-based device.

In particular, as used herein, the user device(s) 42 may include, but are in no way limited to a desktop computer, laptop computer, tablet computer, mobile or handheld device such as a mobile or cellular telephone, gaming device, etc. In this manner, the user device(s) 42 may include a computer processor, memory, storage device, and one or more communication modules which allow the user device(s) 42 to communicate through the network 15 in order to, for example, access the product catalog or other features of the marketplace 20 as described in accordance with the carious embodiments herein.

For example, the network 15 or communication channel used herein may be defined as virtually any data, communication or computer network, including but not limited to the Internet, global telex networks, data or TCP/IP networks, such as Wide Area Networks (WAN), Metropolitan Area Networks (MAN), Local Area Networks (LAN), Internet Area Networks (IAN), and/or one or more telecommunication networks, including for example, wireless mobile telecommunications technology (e.g., third generation or 3G networks, fourth generation or 4G networks, fifth generation or 5G networks, long-term evolution or LTE networks, etc.).

In any event, the user, consumer or developer, generally referenced as 40 in FIGS. 1 and 11, for example, may access the product catalog 110 of the marketplace 20 through the network(s) 15 by operation of a user device 42. For instance, using an internet browser, an application or other method on the user device 42, the user or developer 40 may access and browse the marketplace 20 and/or product catalog 110 made available on or via the marketplace 20. In doing so, the user, consumer or developer 40 may view the various assets of all or some (e.g., targeted) products (e.g., APIs, SDKs, etc.), such as product features, document libraries, specifications, frequently asked questions or FAQs, recommended products, user reviews, etc.

In some embodiments, the user, consumer or developer may be able to try a product before purchasing or subscribing to the product. The demo or ‘try-it-out’ feature of at least one embodiment of the present invention may allow the user, consumer or developer 40 limited or unlimited access to the product for a defined or specified period of time, after which the demo version of the product will expire. In order to continue using the product, the user, consumer or developer 40 will then need to purchase or subscribe to the product, as described in further detail below.

A further feature of the marketplace 20 or product catalog 110 thereof may allow the user, consumer or developer 40 to write or submit a review, rating or comment with regard to a particular product 115. The review, rating or comment may be made available for others to view, and in some cases, a targeted or specific group of other users or developers.

In addition, through the product catalog 110 or marketplace 20, the user, consumer or developer 40 of at least one embodiment may be able to view products 115 or product SKUs of one or multiple organizations. The user, consumer or developer 40 can then select one or more SKUs or products of his or her interest to subscribe or purchase. Of note, if the developer or user 40 selects a monetized SKU or a monetized product (e.g., a product or SKU tagged or identified by the system as being monetized), as described herein, then the developer or user 40 will need to purchase a rate plan, as defined, for example, by the product owner or vendor.

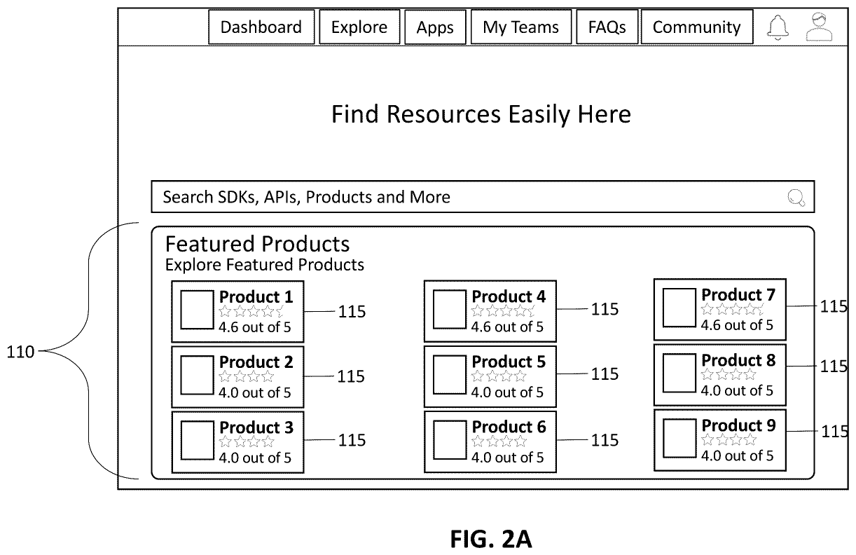

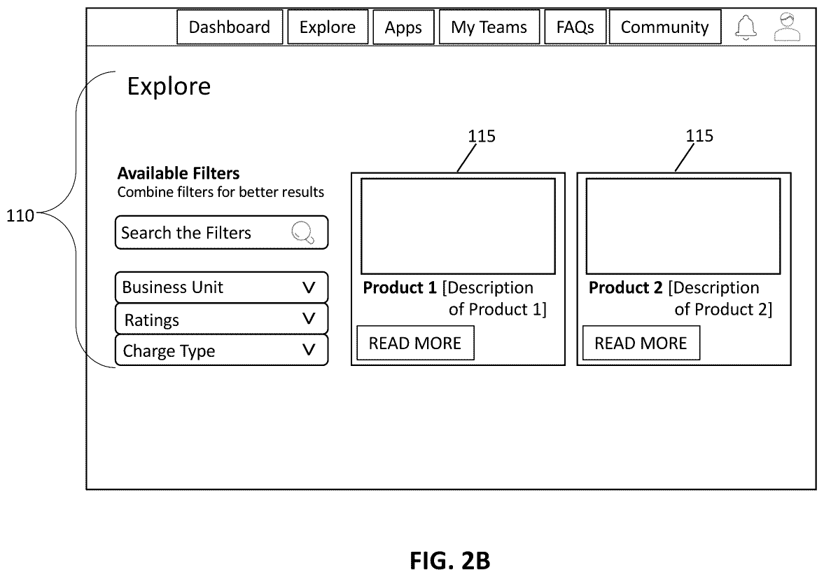

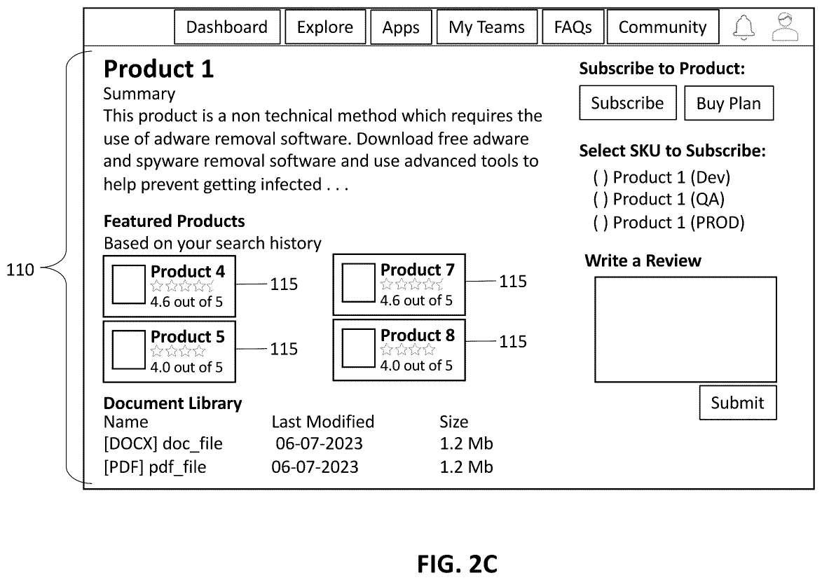

With reference to FIGS. 2A, 2B and 2C, exemplary screenshots are provided which illustrate the product catalog 110 as described in accordance with at least one embodiment of the present invention.

In particular, FIG. 2A illustrates an exemplary homepage, landing page or other page providing various menu items (e.g., “DASHBOARD,” “EXPLORE,” “APPS,” “MY TEAMS,” “FAQs.” And “COMMUNITY.”). A search bar is provided where the user or developer 40 (or other publishers) is/are able to enter keywords or search terms in an effort to locate various APIs, SDKs, or other products 115 that may be made available through the marketplace 20 of the present invention.

Furthermore, still referring to FIG. 2A, in at least one embodiment, various featured products may be presented to the user. Featured products may be manually selected or automatically selected by the system or method of the present invention based on one or more criteria, such as most popular, recently purchased, new products, products in which the particular user may be interested (e.g., based on prior activity, searches, purchases, user profile information, etc.)

FIG. 2B illustrates an exemplary screenshot where a user or developer 40 may explore the product catalog 110 using filters, search terms, etc.

FIG. 2C illustrates an exemplary product detail page showing a written summary or product details, featured products, and a document library as presented in the product catalog 110 of at least one embodiment of the present invention. In this example, the user, consumer or developer 40 may purchase a desired product by selecting “Buy Plan” or other similar designation. In some embodiments, the plan or the rate plan associated with the product 115 is defined by the product owner or vendor, as described further below.

Furthermore, another feature of at least one embodiment of the present invention includes a unique product owner dashboard, which is a location, application or module accessible by the product owner, publisher or vendor 30 where the product owner, publisher or vendor 30 is able to view all of the products 115 (irrespective of the number of API gateways, for example) that are owned by the product owner, publisher or vendor. In particular, using the dashboard (accessible via a computing device communicative with the network 15), the product owner, publisher or vendor is able to onboard or add a product 115 to the marketplace 20 and to manage all of the products (irrespective of the number of API gateways) that are owned by the particular product owner.

In addition, using the dashboard, or other like module or application, the product owner or vendor is also able to target the audience (e.g., particular user(s), group(s) of users, etc.) to whom the product 115, API SKUs and associated assets (e.g., detailed description, summary, ratings, comments, etc.) are available. Except API SKUs, all of the digital assets can be associated with more than one product.

In some cases, the product owner is able to approve and/or reject a subscription, for example, if the subscription requires product owner or vendor approval. More specifically, in the event a developer or user communicates a desire to subscribe to a product, in some cases, the subscription will not begin unless and until the product owner or vendor provides approval.

Furthermore, using the dashboard, the product owner or vendor of at least one embodiment is able to create and manage rate plans; monetize an existing or a new API SKU in a product, see a list of all rate plans created by the particular product owner or vendor; and can view reports and metrics of each plan (e.g., how many people have purchased a rate plan, how many units of rate plans have sol, revenue earned for each rate plan, etc.)

In some cases, in order for a SKU or product to be monetized (e.g., in order for a SKU or product to require a rate plan for purchase), the SKU or product must be tagged as monetized (e.g., by the product owner) and the SKU or product must belong to an organization that is set up as monetized. It should be noted that a single product can have or be associated with multiple SKUs. In some implementations, an API SKU can have only one active rate plan at a particular period of time. A product can inherit rate plans from the SKUs associated with it. If there is an active plan with a certain product, then a new plan with the same product will be saved as a “draft” version and only the product owner or vendor can publish it once the active plan expires or is cancelled. Of note, however, in a least one embodiment, the user(s) or developer(s) will only see the active rate plan(s).

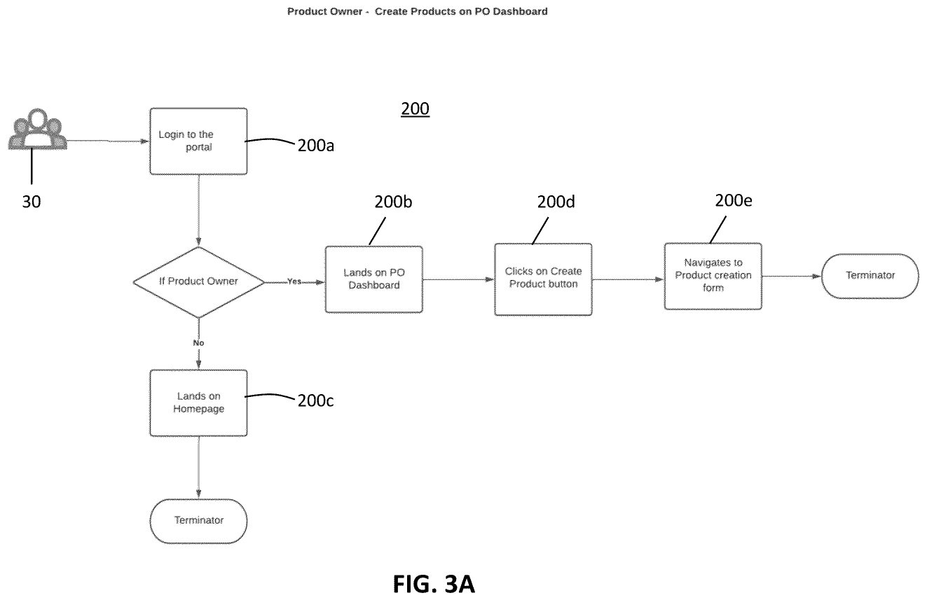

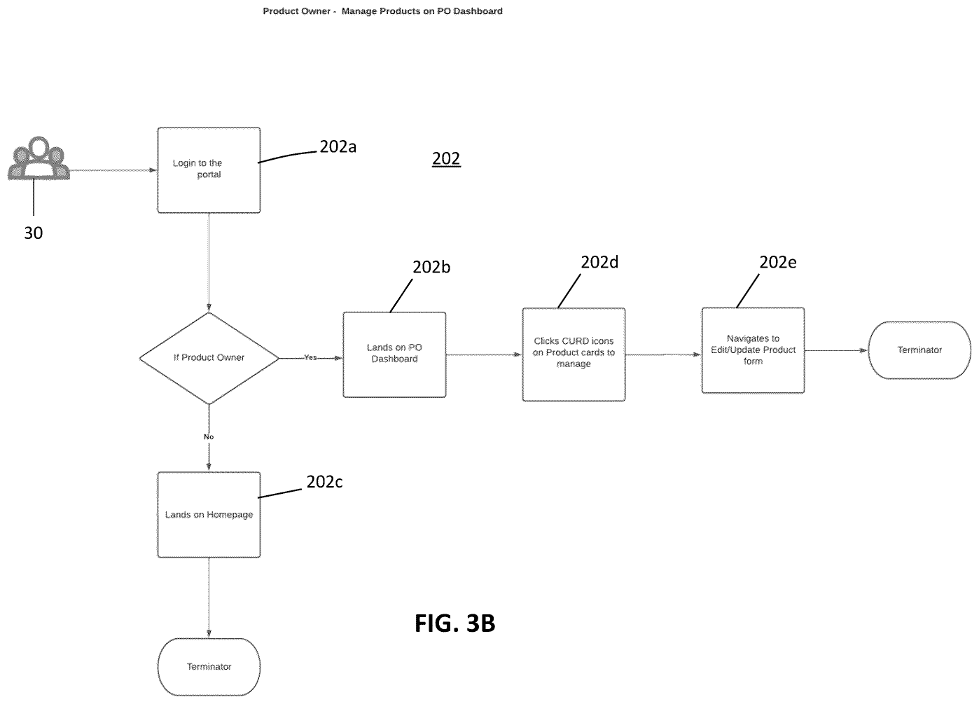

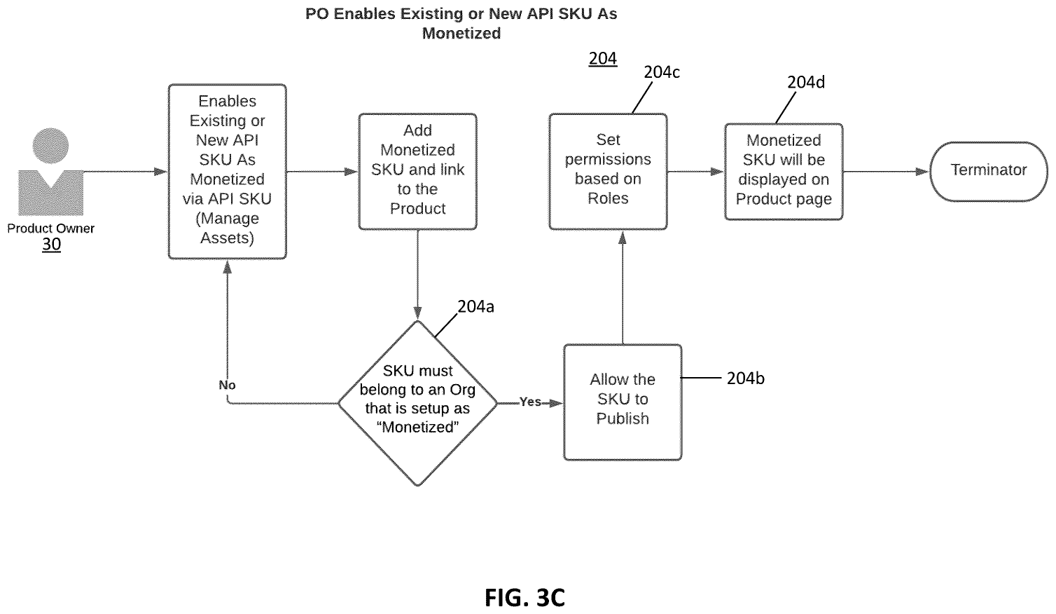

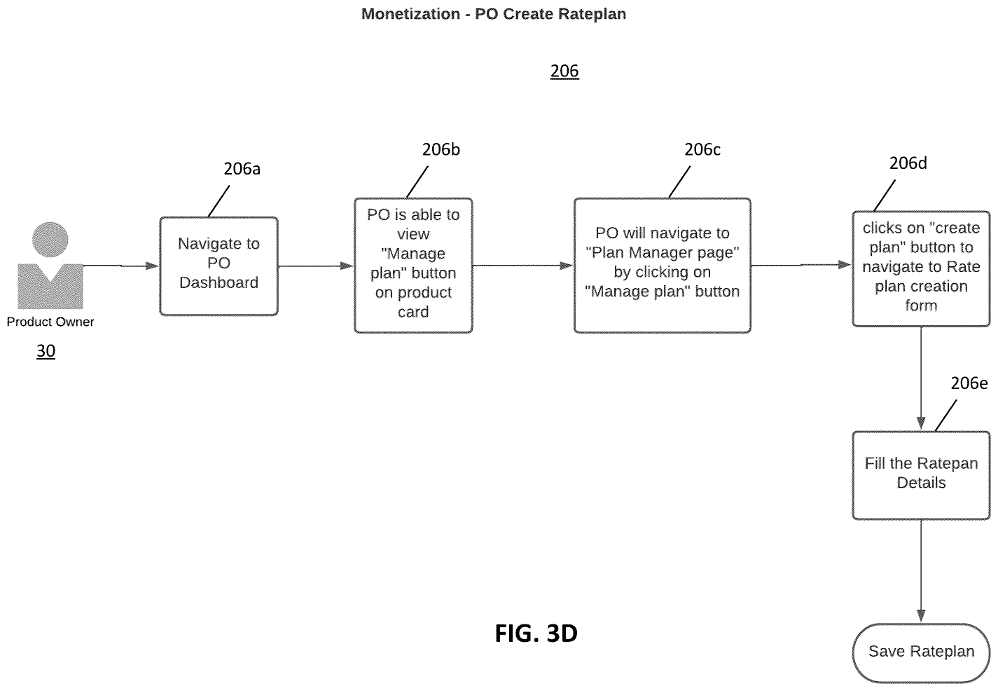

FIGS. 3A-3D illustrate exemplary workflows for the product owner or vendor in accordance with at least one embodiment of the present invention. More specifically, FIG. 3A illustrates an exemplary workflow, represented as 200, for a product owner 30 to create products using the product owner dashboard. More specifically, the product owner 30 will log into the system 10 (as shown at 200a) and land on the Product Owner Dashboard, 200b. If a user logs in and is not a product owner, then that user will be directed to a homepage or other landing page, 200c. The product owner can then click on or navigate to a “Create Product Button) 200d or other similar button, and then navigate to a “Product Creation Form,” 200e, or other similar form. The form will assist or facilitate the creation of a product, such as an API, SDK or other product. As will be described in accordance with other embodiments, a publisher hub application or module may also be used for publishers or other users to create a product with the system 10.

FIG. 3B illustrates an exemplary workflow for a product owner to manage products 115 using the product owner dashboard. In particular, the product owner 30 will log into the system 10 (as shown at 202a) and land on the Product Owner Dashboard, 202b. If a user logs in and is not a product owner, then that user will be directed to a homepage or other landing page, 202c. Next, the product owner is able to click on or navigate to corresponding icons or card associated with the product which will be updated or edited, as shown at 202d. Once the product is selected, the user is able to then edit or update the product, as shown at 202e.

FIG. 3C illustrates an exemplary workflow 204 for a product owner (PO) to enable existing or new APIs, API SKUs or other products as monetized. In particular, in some embodiments, the SKU or product must belong to an organization that is set up as monetized, as shown at 204a. If and when the SKU or product can be monetized, for example, by belonging to or associated with a monetized organization, then the product will be allowed to publish, 204b, permissions will be set, 204c, and the monetized SKU or product will then be published in the marketplace 20, for example, through the product catalog 110.

FIG. 3D is an exemplary workflow 206 for a product owner 30 to create a rate plan. For instance, the product owner 30 will first navigate to the product owner dashboard, as shown at 206a. From there, the product owner 30 can “Manage Plan” through selection of a corresponding or similar button, link, etc. displayed in association with the product 115, such as on the product card thereof, as generally represented at 206b. The product owner 30 can then opt to manage a plan associated with the product, e.g., by selecting “Manage Plan,” or similar button or link, as shown at 206c and/or “Create Plan,” as shown at 206d. Various rate plan details, such as, rate plan name, price, recurring, timeframe, etc. can be entered or selected by the product owner, as generally shown at 206e.

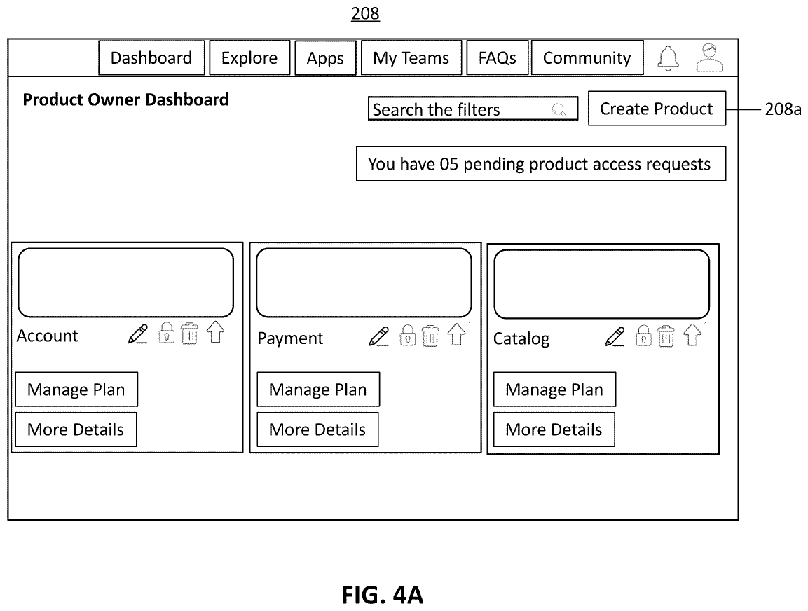

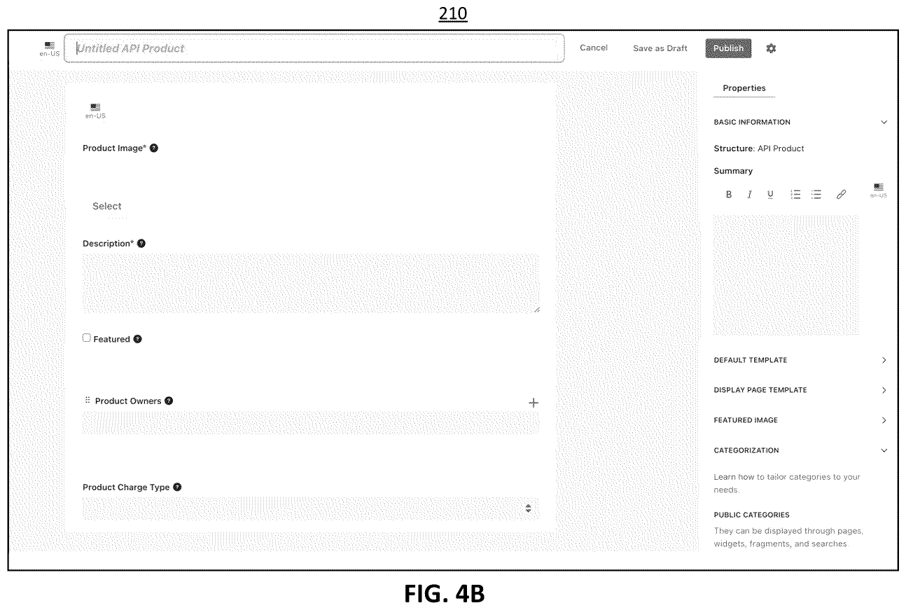

FIGS. 4A and 4B illustrate exemplary screenshots of a product owner or vendor onboarding a product. More specifically, the product owner will first log into the system as a product owner and navigate to the Product Owner Dashboard 208, as shown in FIG. 4A. Next, the product owner will click on or select “Create Product” 208a or other similar feature where the product creation form 210 (FIG. 4B) is presented. The product owner will then fill out the form or otherwise provide detailed information regarding the product which is being onboarded. As an example, the information may include, but is not limited to, a product image, a description of the product, identification of the product owner(s), a product charge type, a summary of the product, etc. This information can be modified or edited at a later time, if needed.

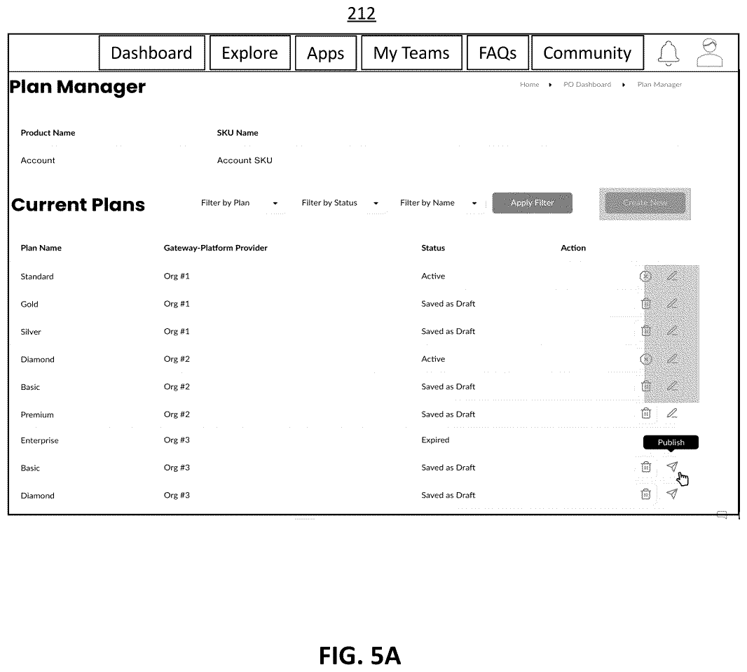

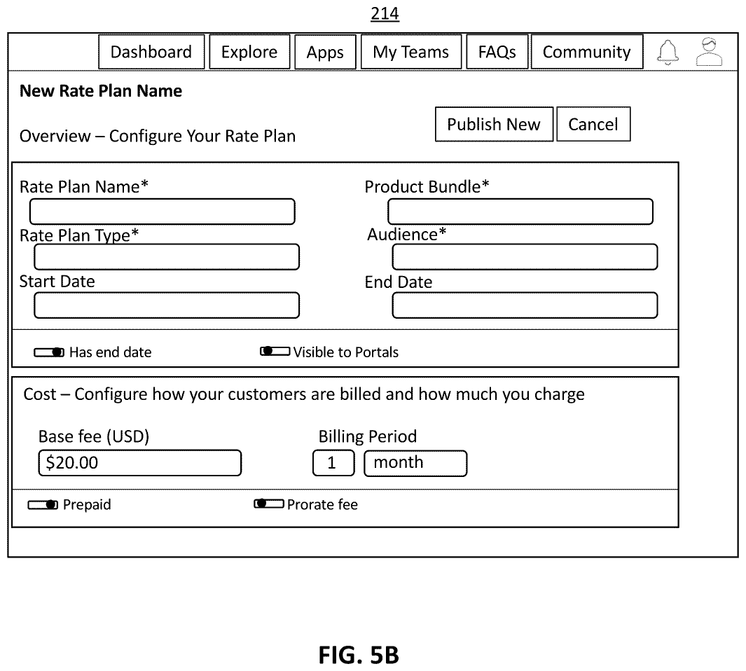

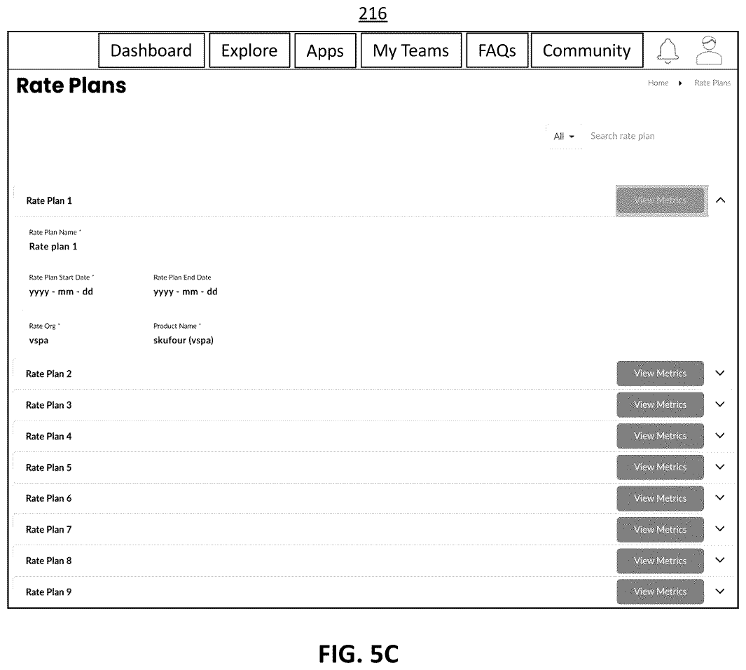

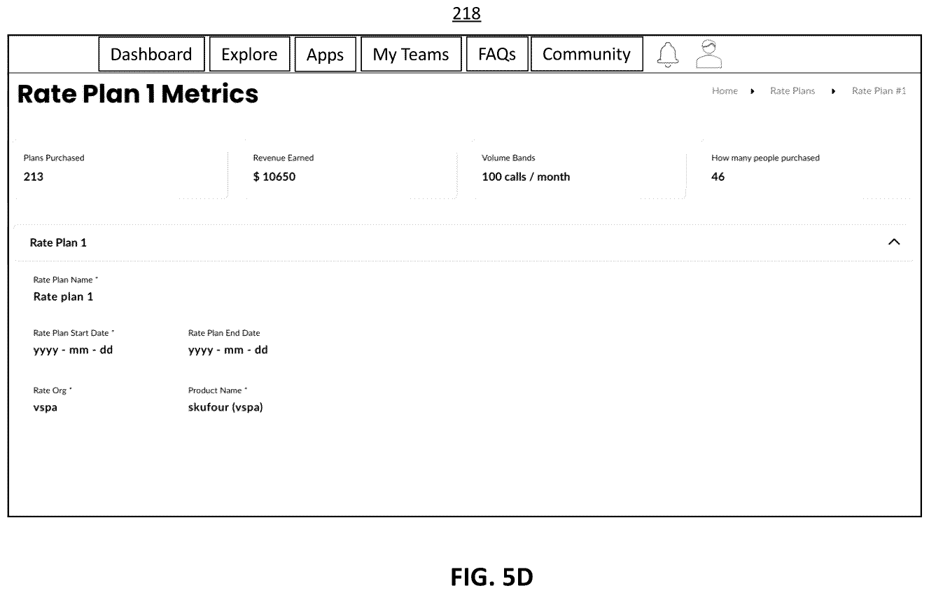

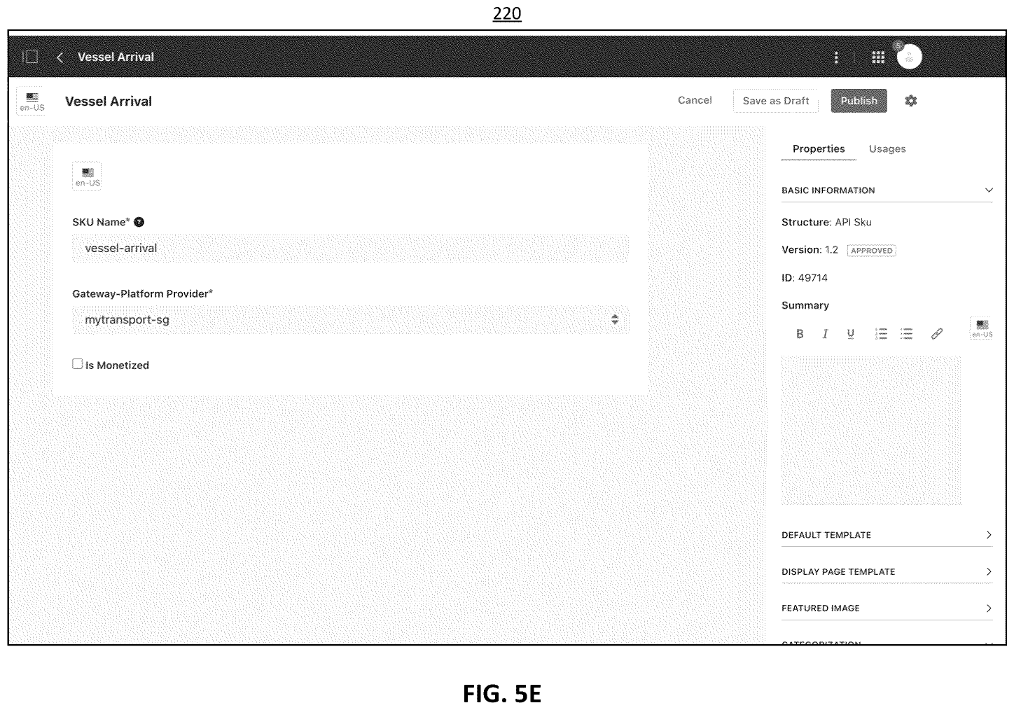

FIGS. 5A-5D illustrate exemplary screenshots for monetizing a product and creation of a rate plan, as disclosed in accordance with at least one embodiment of the present invention.

In particular, FIG. 5A illustrates an exemplary Plan Manager 212 where a product owner is able to view a list of rate plans of specific API SKUs or monetized SKUs associated with a specific product. FIG. 5B illustrates an exemplary screenshot of a new rate plan form 214 where a product owner is able to create a new rate plan. In order to do so, the product owner will fill out the information on the rate plan creation form 214 (as shown in the example), such as rate plan name, rate plan type, product bundle, audience (targeted users), start/end dates, etc. The rate or cost (e.g., fees) and billing period (e.g., per one, two, three, etc. days, months, years, etc.).

FIG. 5C shows a list 216 of all rate plans associated with the product owner or vendor and allows the product owner or vendor to view the metrics 218 associated with each rate plan, as shown for example in FIG. 5D.

FIG. 5E illustrates an exemplary screenshot 220 where a product owner is able to edit an existing SKU or create a new API SKU. In the example, there is a checkbox titled “isMonetized” which can be checked or activated by the product owner in order to indicate to the system that the particular API SKU is to be monetized, for example, with a rate plan.

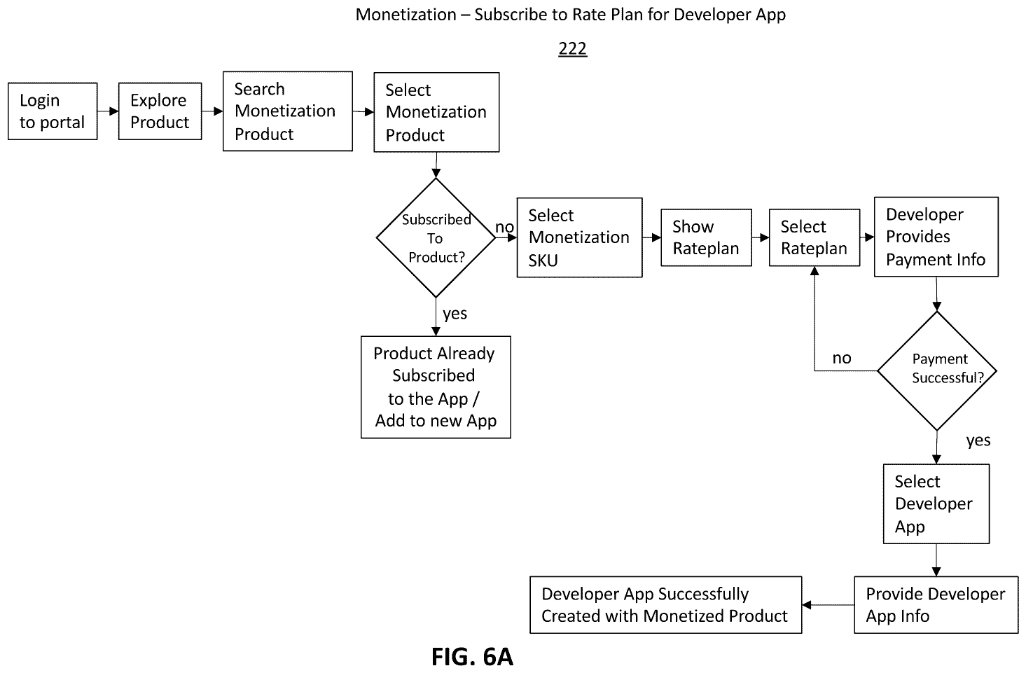

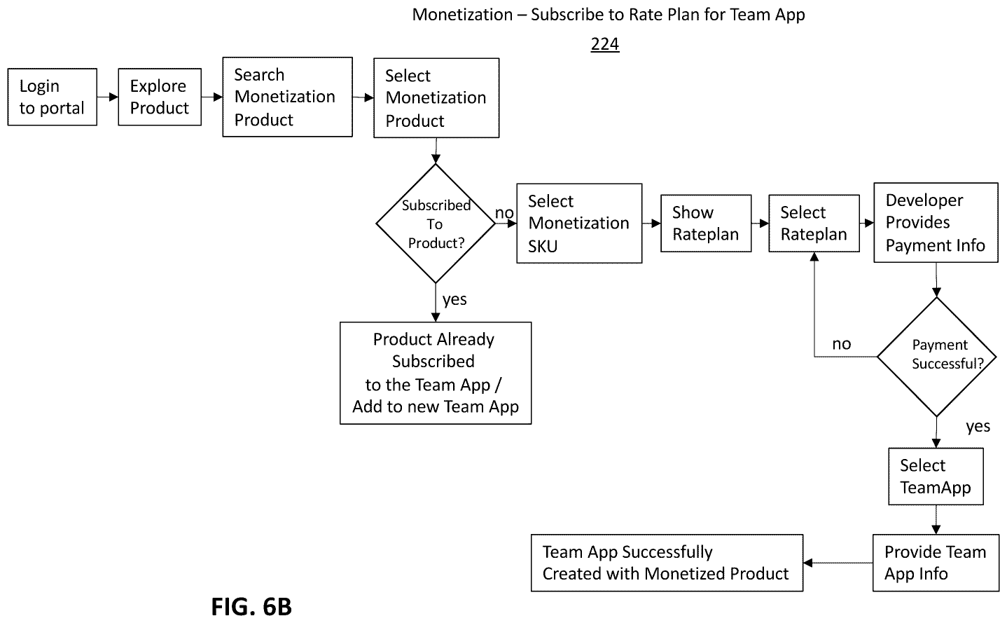

FIGS. 6A-6B illustrate exemplary workflows for the developer or user in accordance with at least one embodiment of the present invention. More specifically, FIG. 6A illustrates an exemplary workflow 222 for a developer or user to subscribe to a rate plan for a developer app., and FIG. 6B illustrates an exemplary workflow 224 for a developer or user to subscribe to a rate plan for a team app.

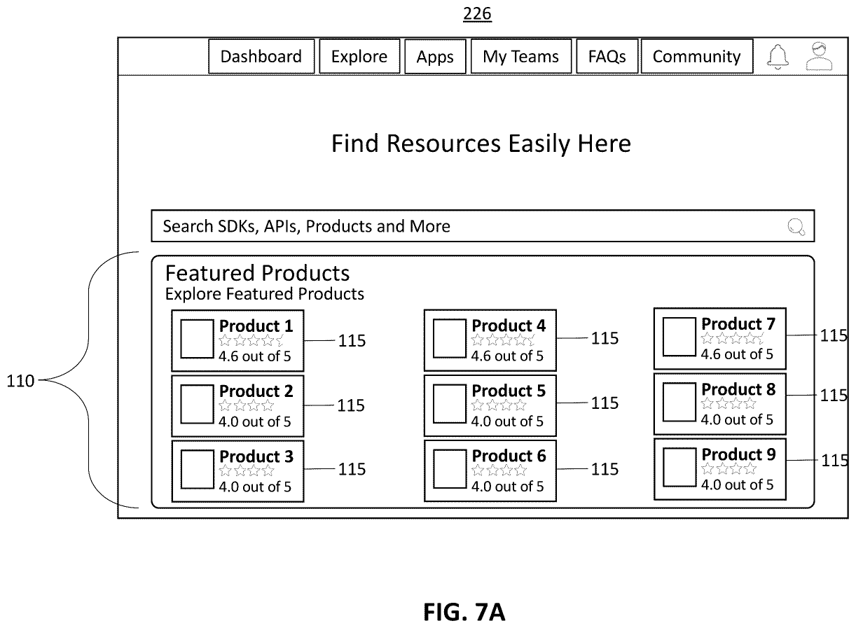

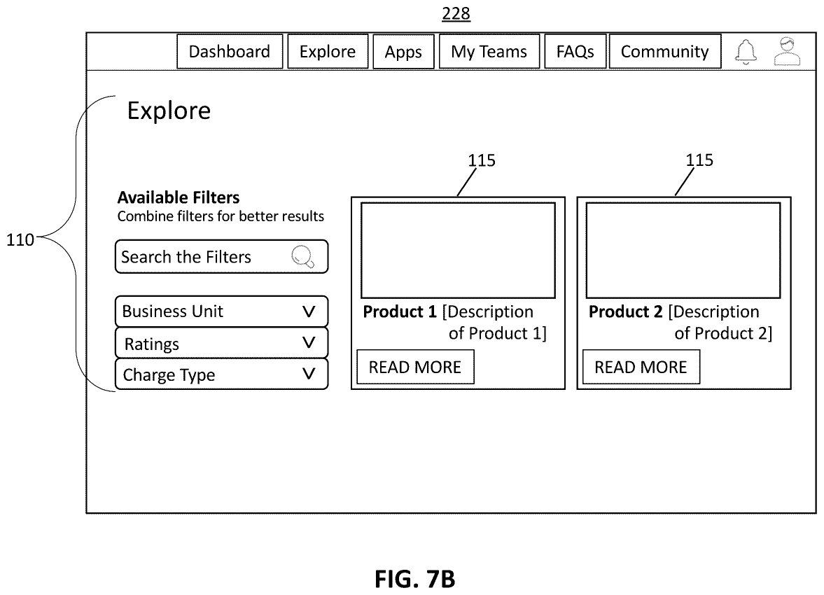

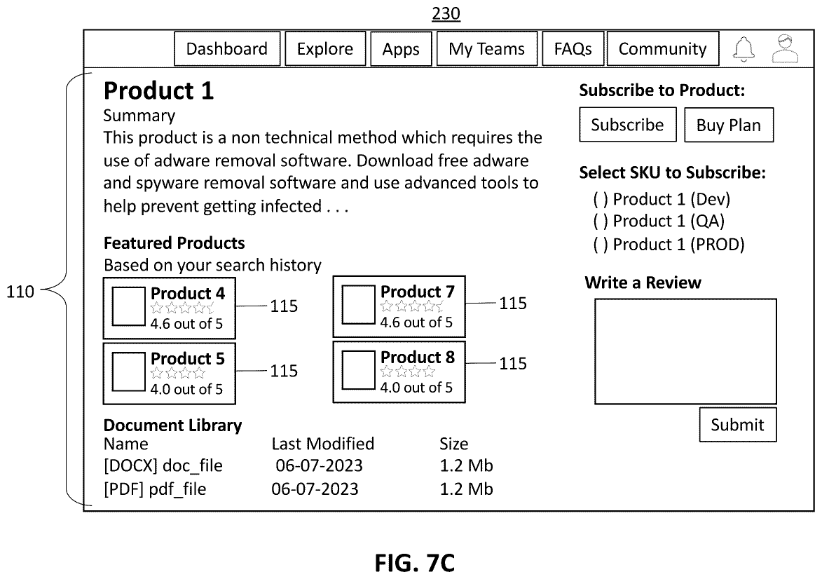

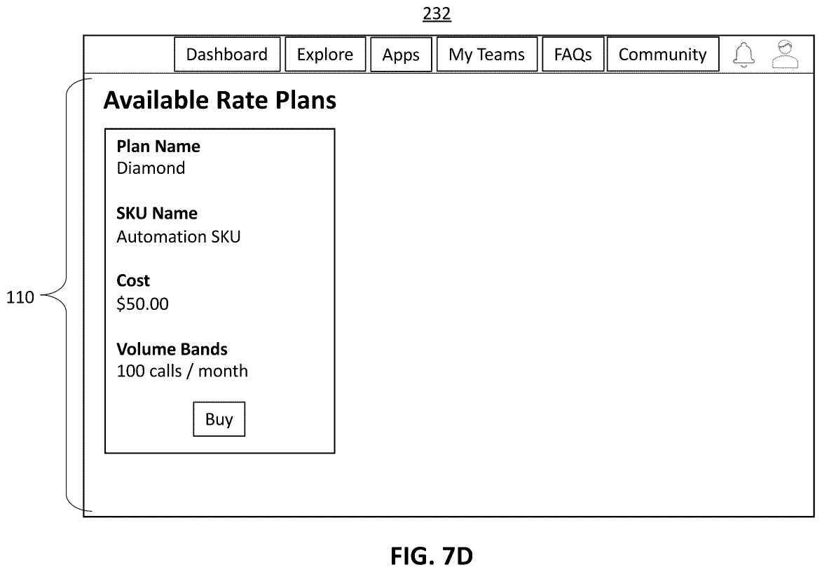

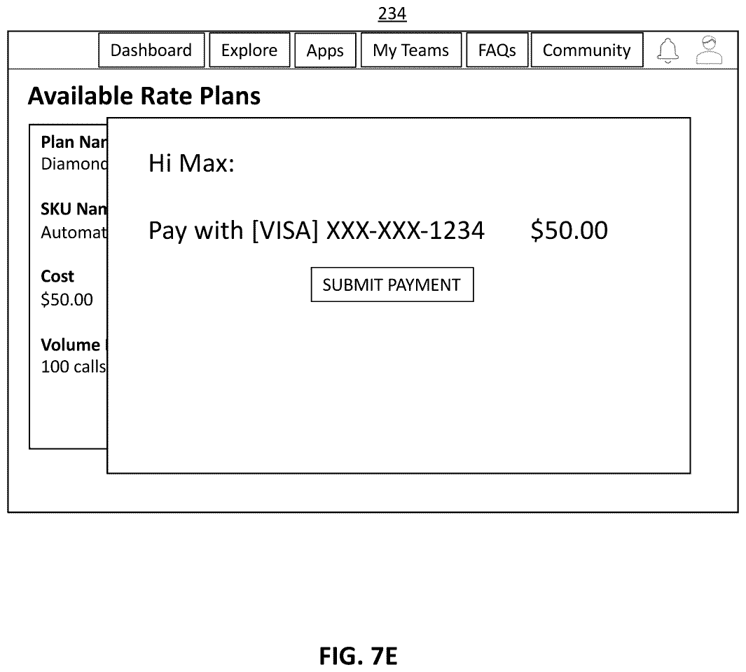

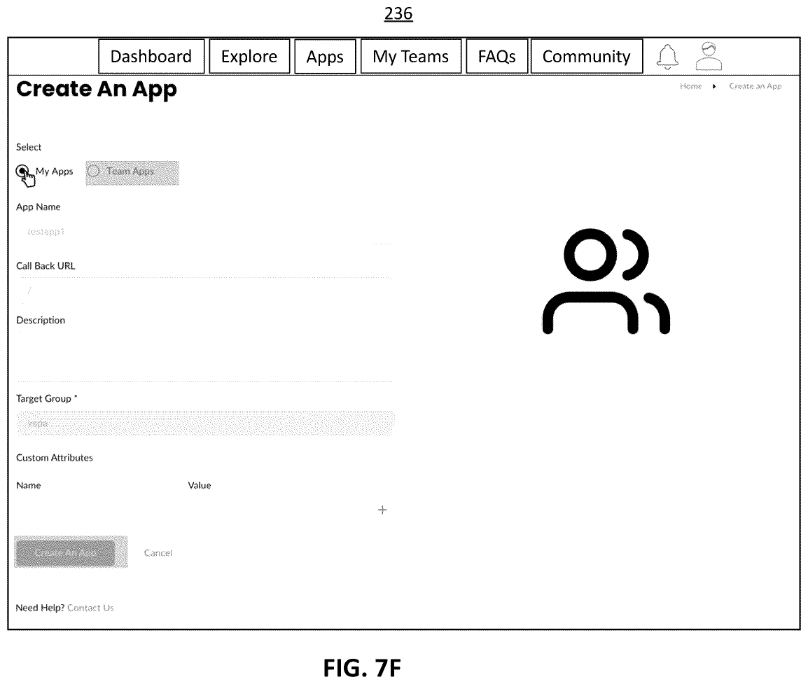

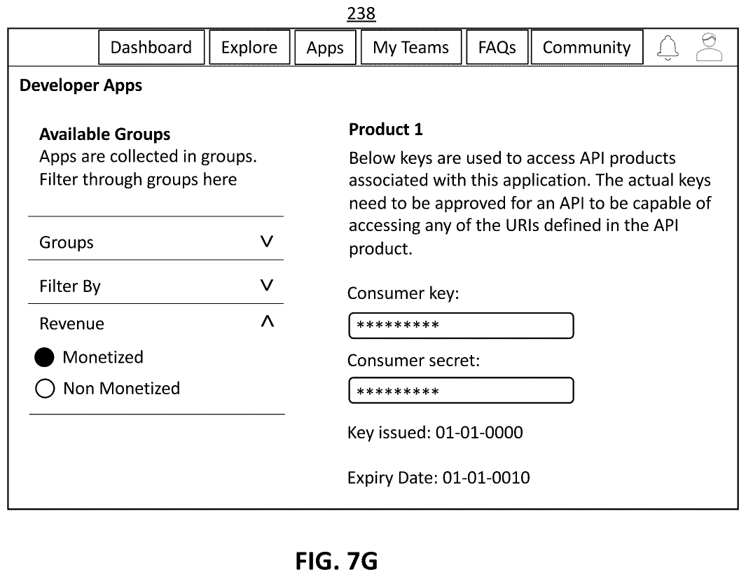

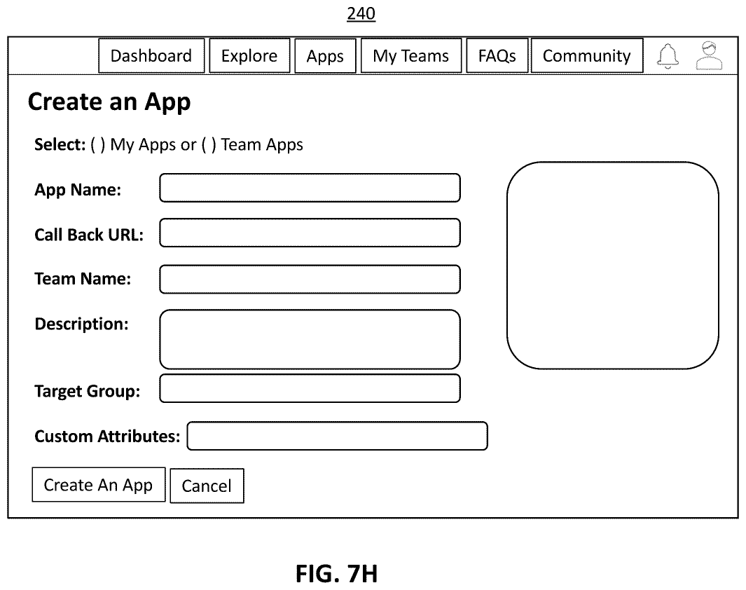

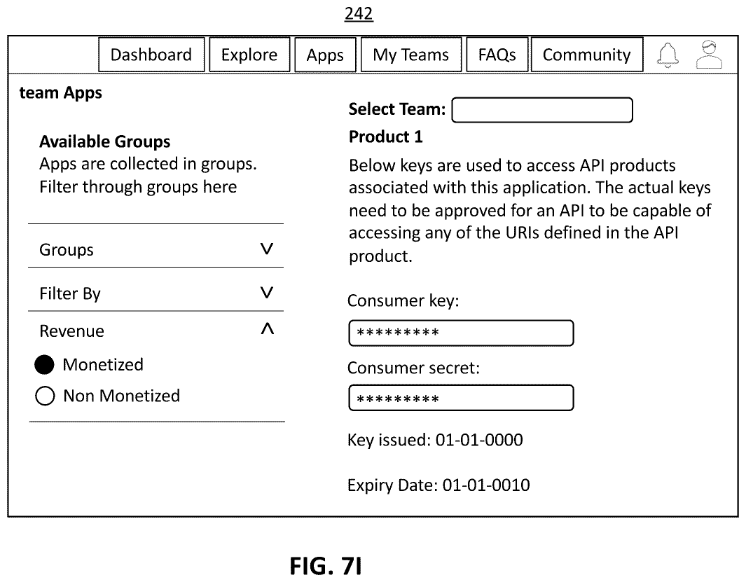

Furthermore, FIGS. 7A-7G illustrate exemplary screenshots of the system of at least one embodiment of the present invention from the perspective of the developer or user to purchase or subscribe to a rate plan for a developer app.

In particular, FIG. 7A shows an exemplary homepage 226 of at least one embodiment with the user or developer logged in. The user or developer may then explore or search the product catalog 110 for a product 115, as described herein and as shown for example in the explore screenshot 228 of FIG. 7B. Selecting a product 115 will show the product detail page 230, as shown in the exemplary screenshot of FIG. 7C. In this view, the user will select the monetized SKU and click on “Buy Plan.” The available rate plans (as defined by the product owner) will appear, as shown in the exemplary screenshot 232 of FIG. 7D. The user will select the rate plan and click “Buy” or other similar feature. Payment information can then be provided, as shown in the exemplary screenshot 234 of FIG. 7E, for example.

Then, as shown in the screenshot 236 of FIG. 7F, the developer or user is able to create an app by selecting “My App” and filling in the information on the form, such as application name, call back URL, description, target group, custom attributes, etc. FIG. 7G shows an exemplary screenshot 238 where the developer is able to view newly created apps on the developer apps page with a Revenue search filter of “Monetized” selected.

FIG. 7H illustrates an exemplary screenshot 240 where a team app is created for a monetized SKU, and FIG. 7I illustrates an exemplary screenshot 242 where the newly created team app is shown on the page with a Revenue search filter of “Monetized” selected.

A further feature of at least one embodiment of the present invention is that the marketplace may allow multiple API gateway capabilities. In this manner, the system administrator may be able to add numerous API gateways to a single marketplace 20. An Organization Manager or other like module or feature may be included where the system administrator(s) is/are able to add new organizations or new groups to the marketplace 20.

As yet another feature of at least one embodiment of the present invention, the product owner, vendor or API producer is able to target the audience to whom he particular product(s) are visible in the marketplace 20. Furthermore, the product owner is also able to target the assets of the product, such as, but not limited to, product features, document libraries, SDKs, API specifications, and FAQs associates with the product. Additionally, the product owner can target the audience to whom the API SKUs are to be visible.

In this manner, each product, SKU and asset can be made visible to or hidden from various users or developers, groups of users or developers, organizations, etc. This can be implemented in many different ways, for example, by tagging each product, product SKU or asset with a label that either includes or excludes a particular user, developer, group or organization. Each user or developer will also include a label (e.g., to define a group, organization, individual, etc. to which he user belongs) that can be matched with or compared to the tag for the system to determine whether the product, SKU or asset should be made visible or hidden. This feature allows the product owners to make various products available for selected users, developers, groups or organizations and can also allow the product owners to control who is able to view the assets associated with each product.

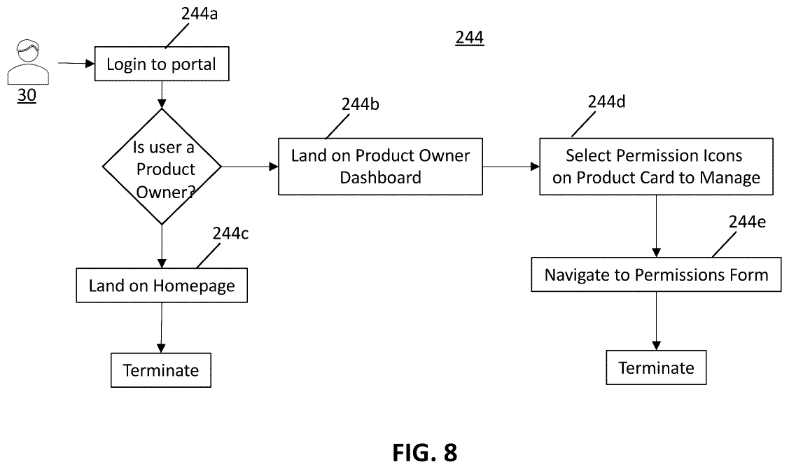

FIG. 8 illustrates an exemplary workflow 244 that allows a product owner to target products, SKUs and/or assets in accordance with at least one embodiment of the present invention. For example, the product owner will first log into the system 10, as shown at 244a and land on the product owner dashboard, 244b. If a user other than the product owner logs into the system 10, the user will be directed to the homepage or a different landing page, as shown at 244c. The product owner will then select a permissions icon (or other similar link or button) on a product card associated with a particular product 115, as shown at 244d. This will navigate the user or product owner to the permissions form, 244e, where permissions and targets can be set and defined.

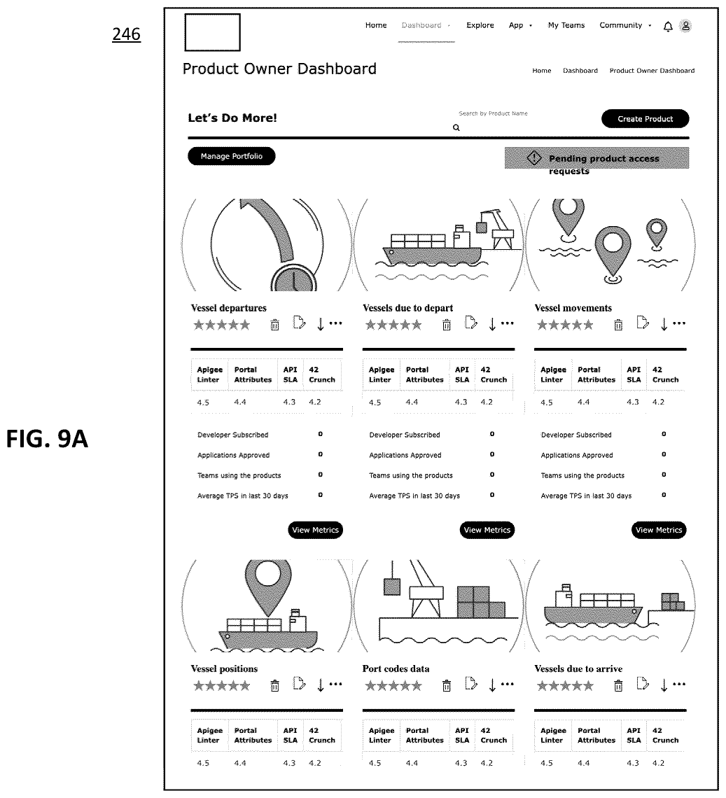

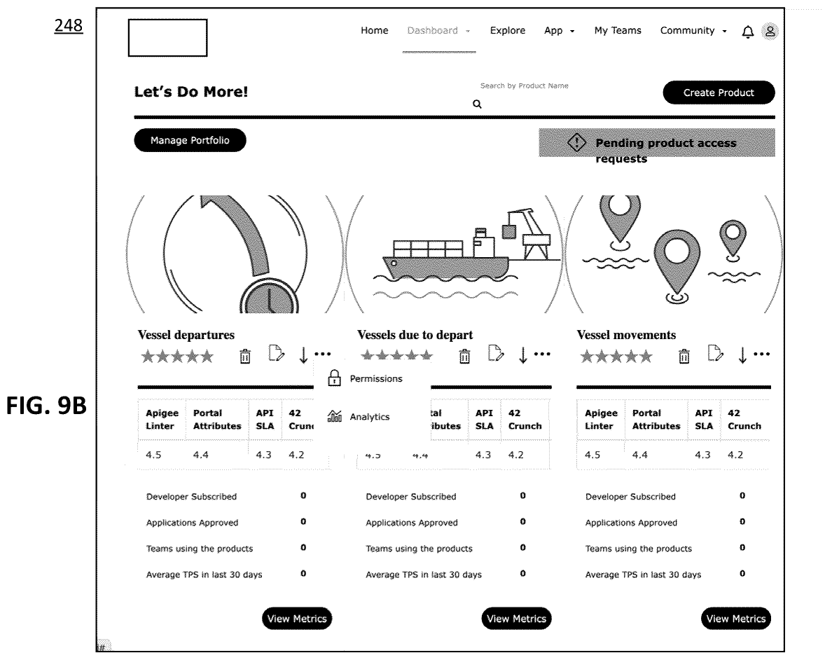

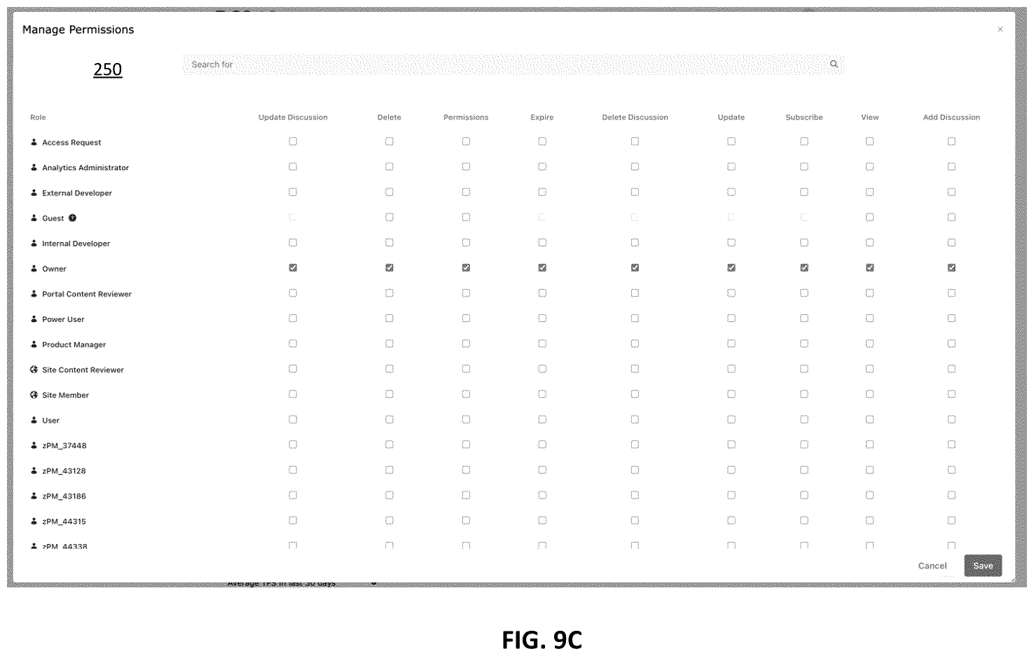

In particular, FIGS. 9A-9C illustrate exemplary screenshots 246, 248, 250 that allows the product owner to control the targeted audience for a product. For instance, FIG. 9A shows an exemplary Product Owner Dashboard where the product owner will click on a “Permissions” icon or its equivalent that is associated with a particular product, as shown in FIG. 9B. This will display the permissions settings page, as shown for example in FIG. 9C where the product owner is able to manage or set permissions for the selected product according to the identified roles.

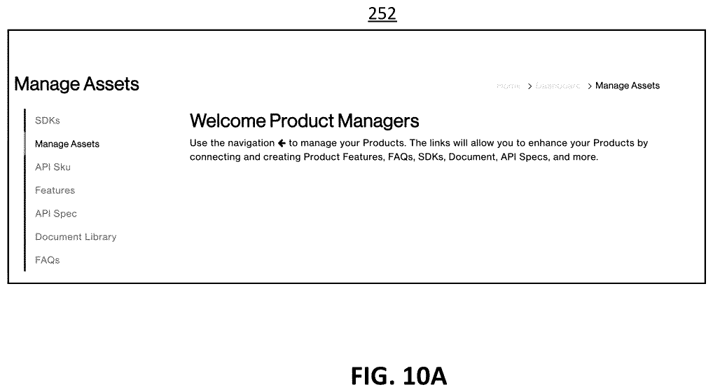

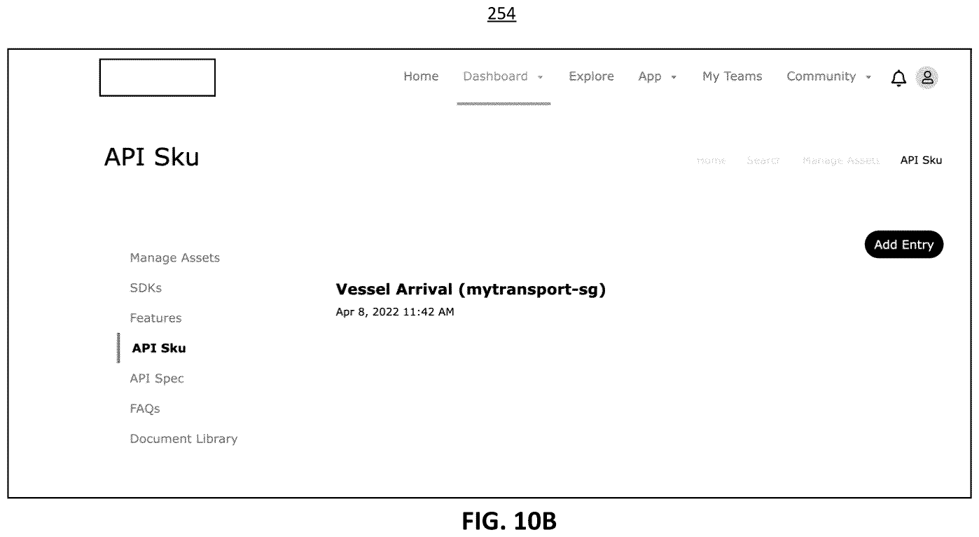

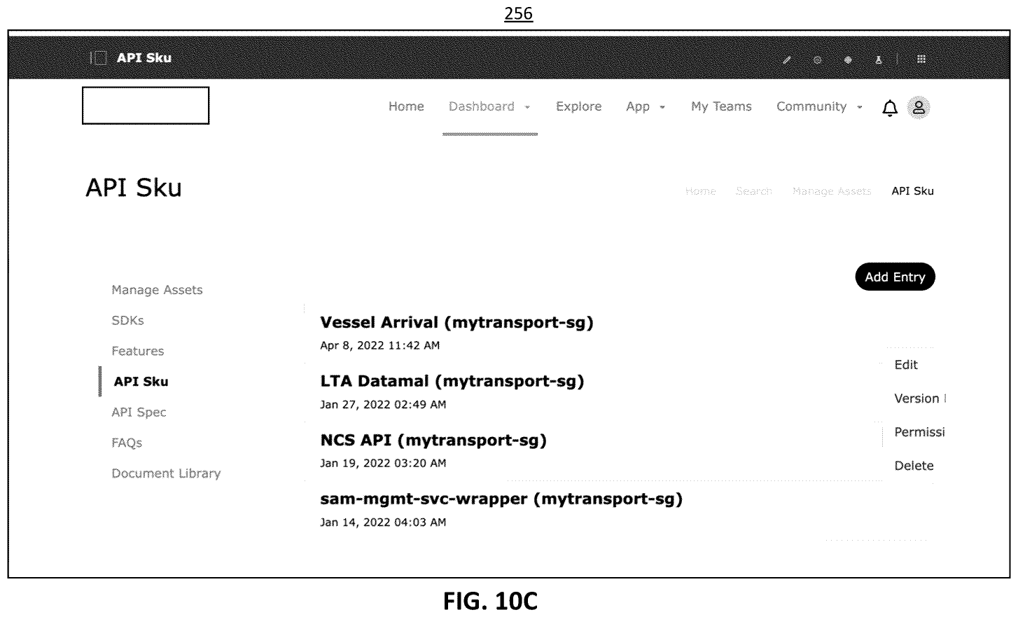

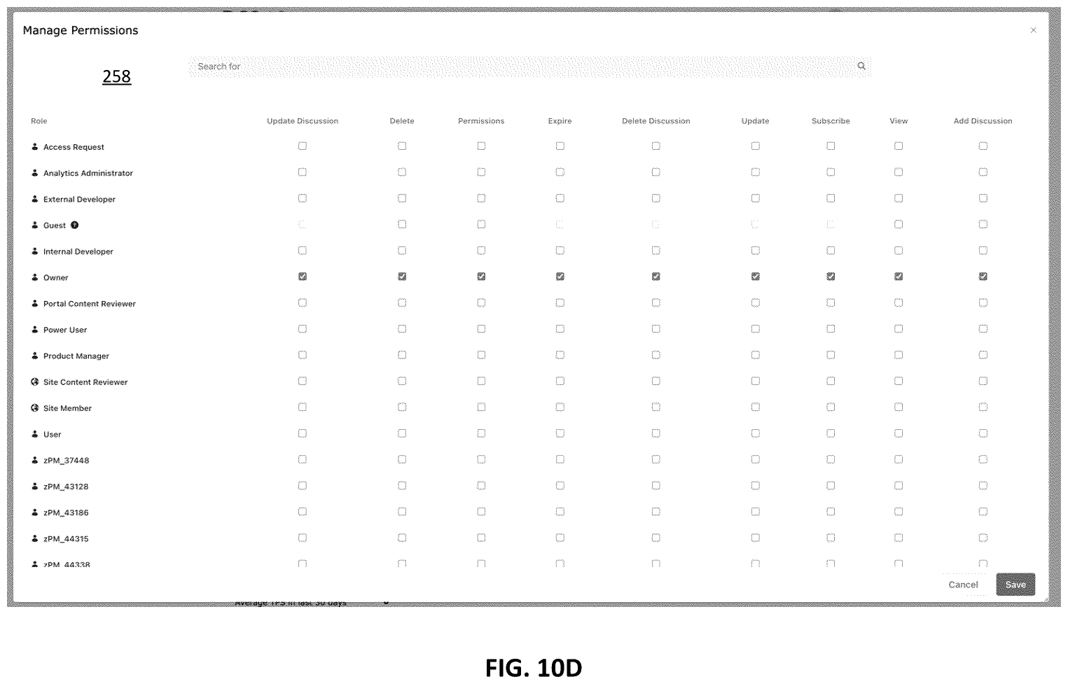

FIGS. 10A-D illustrate exemplary screenshots 252, 254, 256, 258, respectively, which allow the product owner to manage the targeted audience for assets or content associated with a product. For example, as shown in FIG. 10A, the product owner will click on a “Manage Assets” menu item, or an equivalent. This will show several asset options, as illustrated in FIG. 10B, such as SDKs, Features, API SKUs, API Spec, FAQs, Document Library, etc. The product owner will then select any of the assets for which he/she would like to manage, which in the example, API SKUs is selected. In the next view, FIG. 10C, a permission button is selected, which shows the manage permission screen of FIG. 10D where the permissions of the associated asset can be changed.

Additional features of at least one embodiment may include tagging a product, for example, with title tags, meta description tags, heading tags, etc. so that developers, subscribers or users can easily explore and discover the products, for example, by using keywords and search terms. In some cases, the product owner may be able to purchase an option to promote his or her product as a preferred or sponsored product so that it can be more easily seen by prospective users or developers. For instance, a promoted product may appear on the user's homepage, in a featured products list, in a promoted or sponsored product list or grouping, etc.

With reference now to FIGS. 11, 12 and 13, additional features of at least one embodiment of the present invention include a publisher hub module, referenced as 100. In particular, the publisher hub module or application 100 may be a separate application which the user or consumer can download and install on his or her device, or which the user or consumer may access via a web browser or other means on the user device, for example. In some embodiments, the publisher hub module or application 100 may be integrated as part of the marketplace 20 or otherwise accessible in the same or similar manner as the marketplace.

In other words, users of the system 10 of the present invention may access the marketplace through an application (e.g., a mobile application), a web browser, or other like means. In some cases, the publisher hub module or application 10 is part of the same marketplace application or website, while in other embodiments, the publisher hub module or application 100 may be a separate application or a separate webpage, although, as described herein, some integration between the publisher hub module 100 and the marketplace 20 may be implemented in order to publish APIs or other products.

More specifically, the publisher hub module or application 100 of at least one embodiment of the present invention allows publishers 40 to create and manage products, e.g., APIs, which can then be published on or visible through the marketplace 20 for consumers to discover, try, subscribe and use.

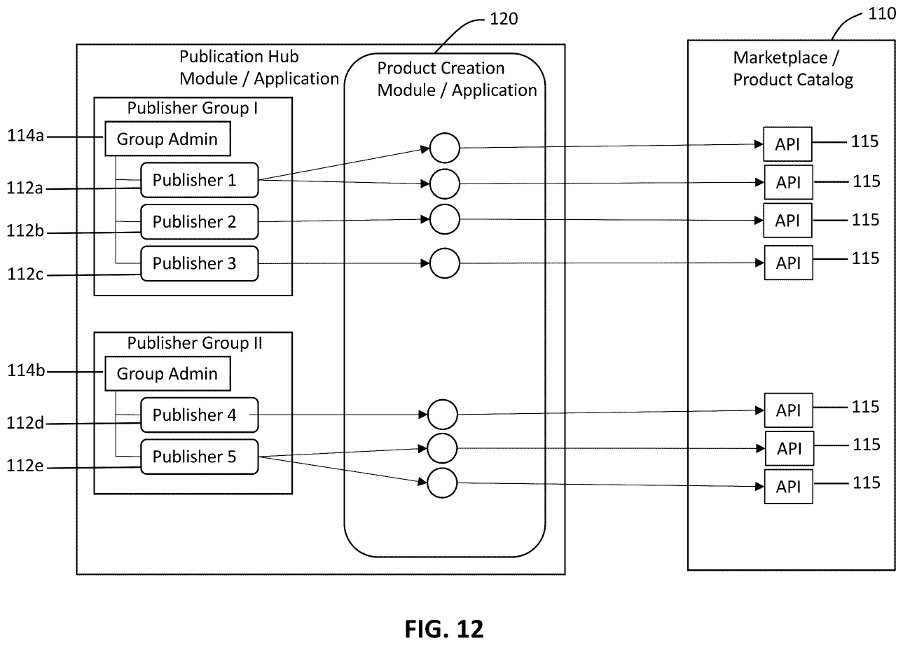

For example, with reference to FIGS. 11 and 12, the publisher hub module or application 100 of at least one embodiment includes one or more publisher groups, represented as 110a, 110b. It should be noted that while two groups are shown, any number of groups 110 may be implemented, whether more or less than two. In any event, a group 110a, 110b includes at least one, but more practically, a plurality of publishers 112a-e associated therewith. With reference to the example provided in FIG. 12, Group I includes three publishers 112a, 112b, 112c associated therewith, while Group II includes two publishers 112d, 112e associated therewith. It should be noted that a publisher 112a-e, as used herein, is an individual or entity that can create and manage APIs and other products in accordance with the various embodiments of the present invention.

In some cases, the publisher group(s) 110a, 110b is a logical data model that is used to represent a group of API publishers who can create products (e.g., APIs and API SKUs) form within the module or application 100.

In at least one embodiment, each of the groups 110a, 110b also includes at least one administrator, 114a, 114b who is an individual or entity that can manage the group 110a, 110b, for example, by adding or removing publishers 40, adding one or more administrators, inviting administrators or publishers to the group, etc. In this manner, the publisher(s) 112a-e and the administrator(s) 114a-b will be able to view and manage the APIs or other products which were created through the corresponding group 110a, 110b.

In some embodiments of the present invention, several managing rules and criteria are implemented with regard to the publisher groups. For example, APIs and products that are created or published by a publisher 112a-e will be owned by the associated group 110a, 110b. As an example, if “publisher 1” 112a illustrated in FIG. 12 were to create an API or other product while associated with Group I, that API or product will then be owned by the group 110a, Group I.

Furthermore, a publisher 112a-e of at least one embodiment may only be associated with a single group 110a, 110b at a time for API and product management, and in some cases, while a member of or associated with a group 110a, 110b, the publisher 112a-e can only have or create APIs or products in accordance with the group 110a, 110b. For example, the group 110a, 110b may have certain rules or criteria which each of the APIs or products must follow or abide in. In such a case, each of the APIs or products created by the publishers 112a-e with that group must follow those rules or criteria.

Still referring to FIG. 12, the publisher hub module or application 100 of at least one embodiment of the present invention may also include a product creation module, generally referenced as 120. In certain embodiments, the product creation module 120 is configured to facilitate the creation of APIs or products by the publishers 112a-e. After the API or product is created, it can then be published in the product catalog or marketplace 20 of the present invention, as described herein, for other publishers, consumers or users to access.

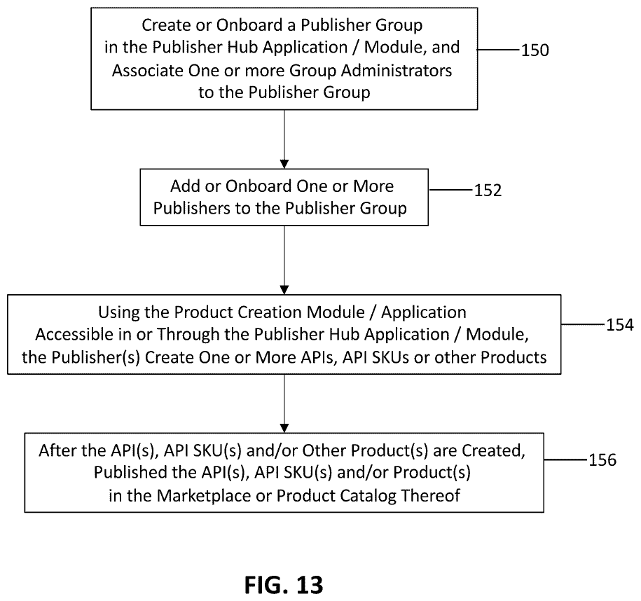

Moreover, with reference now to FIG. 13, a flow diagram is shown illustrating a high-level process associated with the publisher hub module or application. In particular, as shown at 150, the method or process includes creating a publisher group or onboarding an API publisher group. Onboarding of an API publisher group will allow the group administrator(s) 114a, 114b to associate one or more publishers 112a-e and/or one or more additional group administrators to the group 110a, 110b. In addition, once the publisher(a) 112a-e is/are associated with a group 110a, 110b, the publisher(s) 112a-e may begin to create APIs, SKUs or other products for the corresponding or associated group 110a, 110b, for example, through the product creation module 120, as disclosed herein.

Furthermore, through the publisher hub application 100 of at least one embodiments, the users thereof, e.g., the publisher(s) 112a-e, group administrator(s) 114a-b, or system 10 administrators may view the groups 110a-b, for example, under an APIGEE® Organization or other organization. For instance, the publisher hub application or module 100 allows the users to look at or view the onboarded publisher groups 110a-b, for example, under and APIGEE® or other organization. A view details screen displays the group name, the current user's role within the group, and the actions available with respect to each group. The system administrators will view a list of all of the groups onboarded under an APIGEE® or other organization, and will have access to view and update each of the groups. For the other users, e.g., the group administrator(s) 114a-b and publishers 112a-e, the user is presented with only those provider group(s) to which the user belongs. The publisher(s) 112a-e may view the group whereas the group administrator(s) 114a-b are able to view and update the group.

More in particular, viewing and/or updating the group may include the ability to view and/or update details such as, but not limited to, the group name, the publisher(s) within the group, the status of the group (e.g., active/inactive, enable/disable, etc.), organization and deployment targets or rules, a button to navigate or view the APIs, products or SKUs under or owned by the group, etc.

Moreover, updating the status of the group may allow the user (e.g., group administrator) to enable or disable access for publishers 112a-e or group administrators 114a-b to create or update APIs, API proxies, API SKUS, or other products. The system administrator may be able to update the status of a group as active or inactive. Inactive groups will not be able to access any of the creates entities or products under the group.

Furthermore, onboarding a publisher 112a-e into a group 110a-b, as shown at 152 in FIG. 13 for example, will allow the onboarded or added publisher 112a-e to being creating APIs, API SKUs or other products for the group. If a publisher is not associated with a group or otherwise onboarded within a group, then that publisher is not able to create APIs or other products for the group.

Next, as generally referenced at 154 in FIG. 113, once a publisher 112a-e is added to a group 110a-b, associate with a group 110a-b, or otherwise onboarded into a group 110a-b, then that publisher is able to create APIs, API SKUs or other products for the associated group, for example, using the product creation module, as generally illustrated at 120 in FIG. 12. More specifically, creating or onboarding an API, API SKU or other product will allow the publisher(s) 112a-e to define what capabilities are enforced on the API SKU or other product, which will be created from the published hub application 100 and/or the product creation module 120. This way the publisher(s) 112a-e do not need to know how or what needs to be done on the backend in order to create such an API, API SKU or other product.

More specifically, once an API, API SKU or other product 110 is created it may be bundled with an API resource rather than an API proxy. The API or other product created with then be visible on, published on or accessible on the system platform, such as by being displayed in the product catalog 110 as disclosed herein in accordance with at least one embodiment of the present invention, and as generally shown at 156 in FIG. 13. Once published or presented on the product catalog 110, the API or other product is available for other publishers and consumers to view.

In some cases, the resources added to the API SKU or other product will be part of a single API proxy created and deployed in APIGEE® or other like platform, environment or organization. Each resource will be connected to individual target endpoints and will have certain capabilities which are selected, enabled or provided by the publisher at the time of the product creation or after product creation. In some cases, the API proxy will be deployed in a single APIGEE® or other environment.

As just an example, some of the API capabilities than can be enabled or disabled for an API or other product created by the publisher through the product creation module includes: front end security (via client ID, API key, OAuth2, Basic Auth, JWT, etc.), traffic management, CORS, Target security, logging, etc.

As provided above, once the API or product is deployed or published in the product catalog 110 or other location, the users (e.g., consumers, publishers, administrators) can view the product and several details associated with the product. As an example, some of the details made available may include the product name, basepath, quota, deployment target and the actions available with respect to each product, options, capabilities, resources, etc.

Furthermore, after the API, API SKU or other product 115 is deployed or published, it can still be updated by the publisher who created the product, or in some cases, other publishers or administrators. Updating a product may include the ability to enable or disable capabilities of an existing product, adding or removing resources of the product, modifying or updating the quota rate limits associated with the product, etc.

An API, API SKU or other product 115 can also be deleted after it has been deployed and published in the product catalog or elsewhere. For example, deleting an API, SKU, Proxy or product will delete it from APIGEE® or other environment and will delete or remove access to or visibility of the product from the product catalog or portal of the present invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

1. A multi-vendor marketplace accessible by a plurality of consumers through a network, the marketplace comprising:
a product catalog comprising an aggregation of a plurality of products, each of the plurality of products being associated with at least one publisher,
wherein at least one of the plurality of products is selectively targeted to at least one defined group of consumers,
wherein each of the plurality of products comprises a plurality of product assets associated therewith, wherein the plurality of product assets associated with the at least one of the plurality of products is selectively targeted to the at least one defined group of consumers, the plurality of product assets being defined as comprising at least one of a product description, frequently asked questions, or a software development kit,
wherein at least one of the plurality of products comprises a monetized product, the monetized product comprising a rate plan associated therewith, the rate plan comprising a monetary component and a recurring time component, wherein purchase of the rate plan is required for a consumer to retain access to the monetized product.

2. The multi-vendor marketplace as recited in claim 1 wherein at least one of the plurality of products comprises an application programming interface.

3. The multi-vendor marketplace as recited in claim 2 further comprising a plurality of publisher groups, each of the plurality of publisher groups comprising a plurality of publishers associated therewith.

4. The multi-vendor marketplace as recited in claim 3 wherein the publisher group owns the products published in the product catalog by each of the plurality of publishers associated with the publisher group.

5. The multi-vendor marketplace as recited in claim 4 wherein each of the plurality of publishers can only be active in a single publisher group at a time.

6. A system comprising:
a multi-vendor marketplace operated on at least one computer server and accessible by a plurality of consumer devices through a network,
the marketplace comprises a product catalog comprising an aggregation of a plurality of products, each of the plurality of products being associated with at least one publisher,
a publisher hub module comprising a plurality of publisher groups, each of the plurality of publisher groups comprising a plurality of publishers associated therewith,
the publisher hub module further comprises a product creation module configured to facilitate the creation of a product by at least one of the plurality of publishers, and
wherein the product created by the at least one of the plurality of publishers is published in the product catalog of the multi-vendor marketplace.

7. The system as recited in claim 6 wherein at least one of the plurality of products comprises an application programming interface.

8. The system as recited in claim 6 wherein the publisher group associated with the at least one publisher who created the product owns the product.

9. The system as recited in claim 6 wherein at least one of the plurality of products comprises a monetized product, the monetized product comprising a rate plan associated therewith, the rate plan comprising a monetary component and a recurring time component, wherein purchase of the rate plan is required for a consumer to retain access to the monetized product.

10. The system as recited in claim 9 wherein at least one of the plurality of products is selectively targeted to at least one defined group of consumers.

11. The system as recited in claim 10 wherein each of the plurality of products comprises a plurality of product assets associated therewith, wherein the plurality of product assets associated with the at least one of the plurality of products is selectively targeted to the at least one defined group of consumers, the plurality of product assets being defined as comprising at least one of a product description, frequently asked questions, or a software development kit.
